(19) United States
(12) Patent Application Publication
(10) Pub. No.: US 2017/0158785 A1
(43) Pub. Date: Jun. 8, 2017

(54) ISOMERIZATION OF POLYISOBUTYLENE

(71) Applicants: William Jay Colucci, Glen Allen, VA (US); Charles S. Shanahan, Richmond, VA (US); Michel Nuckols, Midlothian, VA (US); Alice Diane Gauthier, Richmond, VA (US); John T. Loper, Henrico, VA (US)

(72) Inventors: William Jay Colucci, Glen Allen, VA (US); Charles S. Shanahan, Richmond, VA (US); Michel Nuckols, Midlothian, VA (US); Alice Diane Gauthier, Richmond, VA (US); John T. Loper, Henrico, VA (US)

(73) Assignee: Afton Chemical Corporation, Richmond, VA (US)

(21) Appl. No.: 14/961,576

(22) Filed: Dec. 7, 2015

(51) Int. Cl. C08F 110/10; C10L 10/06; C10L 1/22

(52) U.S. Cl. CPC C08F 110/10; C10L 1/221; C10L 10/06; C10L 2200/0423; C10L 2270/023

(57) ABSTRACT

Polyisobutylenes (PIBs) containing a high proportion of vinylidene end groups are generally favored over conventional PIBs because of their higher reactivity in reactions that are needed to prepare fuel and lubricant additives. However, detergent additives that have been prepared from conventional PIBs actually perform better than detergent additives prepared from high reactive PIBs. Specifically, detergent additives that were prepared from conventional PIB that was then enriched with tri- and tetra-PIB resulted in altered thermal stability and improved detergency of the resulting compound as compared to the structures which were created using a high proportion of vinylidene end groups.

The present invention relates to polyisobutylene (PIB) that is enriched in macromolecules having certain isomeric forms, methods of preparing the PIB, and its use in preparing detergent additives.

### BACKGROUND

PIB is used for a multitude of industrial applications. Among the various different classes of PIB, low molecular weight PIBs represent a large portion of the overall market due to their intensive use for manufacturing additives for fuel and lubricants. In this regard, a particular type of PIB has been developed for use in preparing lubricant and gasoline additives, namely PIB having an increased proportion of macromolecules in which the double bond is located at the end of the chain, to make the PIB more reactive. This can be achieved by using pure isobutene feedstock and a catalyst based on BF₃, as reported by Mach et al (Lubrication Science 11-2, February 1999 (11) pp 175-185). More recently, it has also been achieved using AlCl₃ in a form of complex with ether (Kostjuk et al, Journal of Polymer Science, Part A: Polymer Chemistry 2013, 51, 471-486).

The structural differences between this more reactive PIB and conventional PIB, and the implications for reactivity, were summarised by Mach et al in the following terms.

Reactivity of PIB

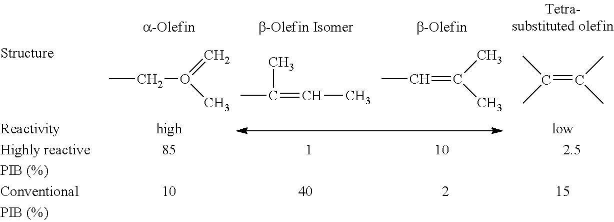

The structures indicated above are referred to herein using the following nomenclature:

| Structure in Table above: | Structure referred to herein as: |
|---|---|
| α-Olefin | Exo |
| β-Olefin isomer | Tri |
| β-Olefin | Endo |
| Tetra-substituted olefin | Tetra |

PIBs containing a high proportion of exo groups (i.e. vinylidene end groups) are generally referred to as high reactive PIB (HR PIB). Since its introduction, HR PIB has generally been favoured over conventional PIB due to its higher reactivity in the post-polymerization functionalization reactions that are needed to prepare fuel and lubricant additives. Expectation in the market place has been that, moving forward, the production of HR PIB would increase progressively, and also that HR PIB containing increasingly high proportions of exo-PIB macromolecules may become desirable (see e.g. Kostjuk et al—citation details noted above).

### SUMMARY

The present invention is based on the surprising finding that, despite the general preference for using HR PIB for preparing detergent additives for fuels and lubricants, a detergent additive that has been prepared from conventional PIB actually performs better, pound for pound, than a detergent additive prepared from HR PIB.

The type of detergent additives envisaged here comprise of course compounds in which a PIB substituent is bonded to a group comprising a polar moiety. It is believed that the superior activity of detergents prepared from conventional PIB arises due to the structure of that part of the PIB group which is bonded to said group comprising a polar moiety. In particular, it seems that the particular structure which arises with tri-PIB (when it forms a bond with the group comprising a polar moiety) imparts altered thermal stability to the resulting compound and improved detergency as compared to the structures which arise with exo-PIB or endo-PIB.

Thus, when preparing detergent additive compounds comprising a PIB substituent bonded to a group comprising a polar moiety, improved efficacy can be achieved by increasing the proportion of tri-PIB, i.e. the proportion of PIB wherein the alkene moiety appears at the end of the molecule and has the structure —CH₂—C(CH₃)═CHCH₃. Typically in this regard the tri group will have the following stereochemistry:

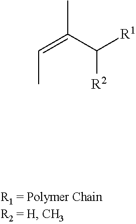

To prepare such a detergent having improved efficacy, PIB that is enriched in tri-PIB can be reacted with a reagent serving as a source of a group comprising a polar moiety, under conditions appropriate for the PIB to react with said reagent so as to form a compound in which the PIB is bonded to the group comprising a polar moiety.

As for the PIB that is enriched in tri-PIB, this can be prepared directly. For instance, polymerisation of isobutylene in hexane with an initiator such as H₂O, MeOH, tBuCl, TMPCl (2-chloro-2,4,4-trimethyl-pentane) or CumCl (cumyl chloride), in conjunction with EADC (EtAlCl₂) in the temperature range of −40 to 25° C. can be used to prepare a PIB product having around 70% tri-PIB and around 30% tetra-PIB, with negligible exo- and endo-PIB. (Dimitrov et al., (Macromolecules 2011, 44, 1831-40). Alternatively, PIB that is enriched in to some extent in tri-PIB can be prepared from conventional PIB or HR PIB, e.g. by exposing the PIB sample to a Lewis acid or Bronsted-Lowry (protic) acid.

In relation to both of these approaches, though, it is noteworthy that due to the preference in the art to use HR PIB (with its high levels of exo-PIB), as a general rule the preparation of PIB enriched in tri-PIB is specifically avoided, particularly when the PIB is envisaged for use in preparing a detergent additive. The consequential loss of exo-PIB is seen as undesirable.

In situations where PIB contains both tri-PIB and tetra-PIB, the effective proportion of tri-PIB can be increased by reacting the PIB with said reagent having a group comprising a polar moiety under conditions in which the tetra-PIB will react to produce tri-PIB. This enhances the effective proportion of tri-PIB in situ. Thus, tri-PIB can be formed readily from tetra-PIB under suitable conditions, e.g. in the presence of a source of protons. A mechanism for this process, following cation formation, has been described by Dimitrov et al. (Macromolecules 2011, 44, 1831-1840). That reaction pathway has been summarised by Kostjuk et al. (citation details noted above) in the scheme reproduced below, in connection with the formation of tri-substituted olefinic end groups during the EtAlCl₂(AlCl₃)-co-initiated cationic polymerisation of PIB.

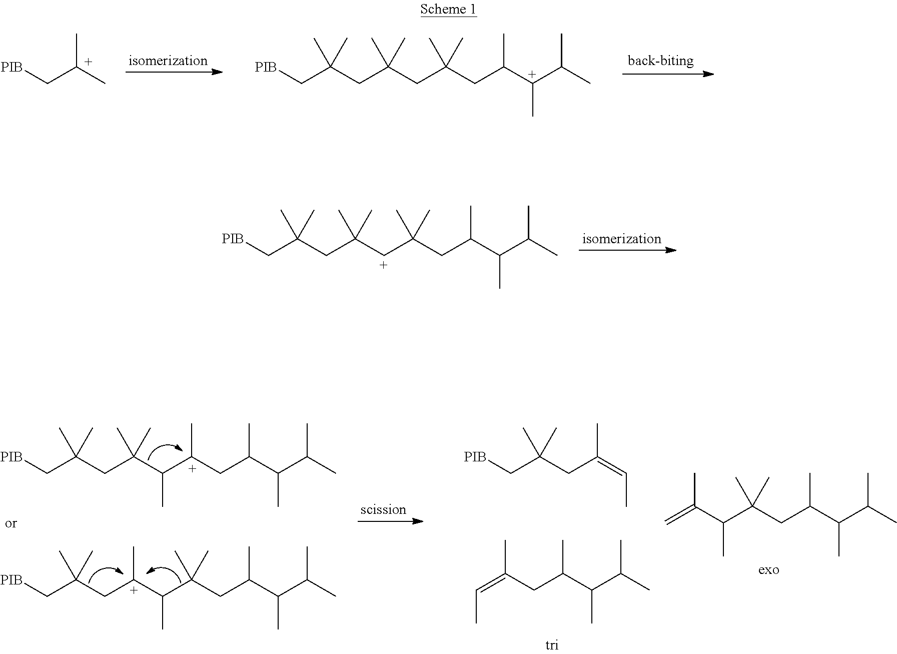

In this regard, the present invention also relates to a method of preparing PIB that is highly enriched with tetra-PIB. Such a highly enriched PIB can advantageously be used as a precursor for PIB that is highly enriched in other isomeric forms.

For instance, PIB that is highly enriched in tetra-PIB can be used to prepare a PIB reagent that is highly enriched in tri-PIB, or (if different conditions are used) a PIB reagent that is highly enriched in exo-PIB. Alternatively, PIB that is highly enriched with tetra-PIB can be used to form tri-PIB in situ during the preparation of a detergent product. In this regard, the fact that the tetra-PIB can be efficiently reacted to produce other types of PIB in this way means that the high levels of tetra-PIB enrichment possible in accordance with the present invention can effectively be transferred to provide similar levels of tri- and exo-PIB enrichment.

PIB that is highly enriched with tetra-PIB can be prepared by subjecting a sample of PIB containing a high proportion of exo- and endo-PIB (such as a typical HR PIB) to double bond isomerisation in circumstances in which the back-biting step depicted in Scheme 1 above is inhibited. For instance, the PIB sample can be subjected to double bond isomerisation in a molecular sieve, wherein the molecular sieve limits the extent to which the macromolecules can adopt the conformation that is needed in order for this intramolecular cyclic reaction to occur.

As regards the mechanism for the formation of tetra-PIB in this regard, Dimitrov et al. (citation details noted above) have proposed the reaction pathway set out below. In this regard, the isomer labelled 4′ in the scheme below (i.e. one of the two tetra-PIB isomers) was reported to be most preferred.

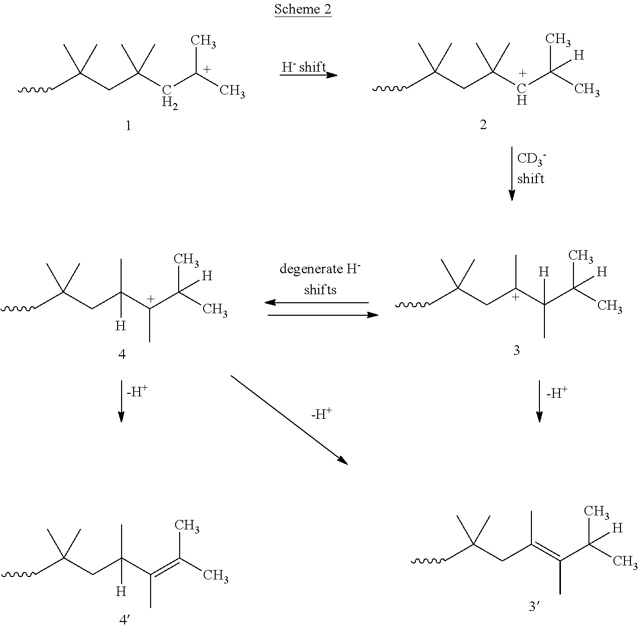

In line with the scheme set out above, in the PIB that is enriched with tetra-PIB (and optionally also enriched with tri-PIB, as discussed above), the alkene group having the tetra structure in tetra-PIB should be located within or attached to a terminal C4 unit in the macromolecule, and typically has one of the two structures noted below, with the second structure usually being more preferred:

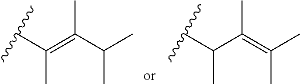

Also, for completeness it is to be noted that cation 1 in scheme 2 can be formed from both exo- and endo-PIB. This is illustrated by the following further reaction scheme:

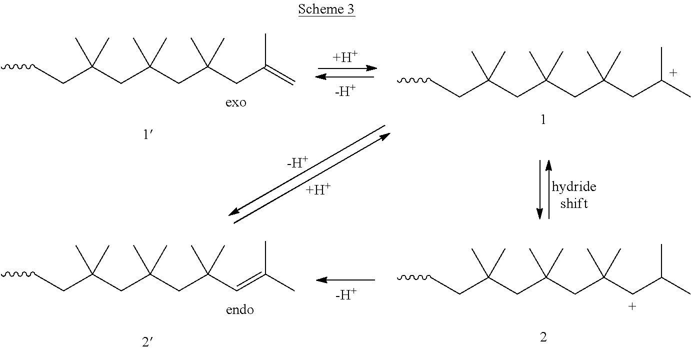

As explained above, PIB that is highly enriched in tetra-PIB can advantageously be used, inter alia:
(1) to prepare a PIB reagent that is highly enriched in tri-PIB,
(2) to prepare a PIB reagent that is highly enriched in exo-PIB, or
(3) to generate high levels of tri-PIB in situ, during the formation of a detergent compound.

In case (3), the PIB that is highly enriched in tetra-PIB can be combined with a reagent having a group comprising a polar moiety under conditions where back-biting (see Scheme 1 above) can arise and indeed is promoted (e.g. protic conditions), thus favouring the production of tri-PIB. The more reactive tri-PIB reacts preferentially with said reagent, so as to form detergent compounds having a structure which, as discussed above, imparts altered thermal stability, and has improved detergent activity.

In case (1), similar conditions to those identified in case (3) may be used to encourage back-biting so as to produce tri-PIB. This approach might be preferable to the formation of tri-PIB in situ as in approach (3), in instances where the PIB enriched in tri-PIB is intended for use in an application wherein the presence of tetra-PIB may be undesirable for some reason.

In case (2), rather than being subjected to conditions that will yield tri-PIB, the PIB that is highly enriched in tetra-PIB may be subjected to thermal treatment so as to form exo-PIB via a retro-Alder-ene reaction according to the mechanism depicted below in Scheme 4.

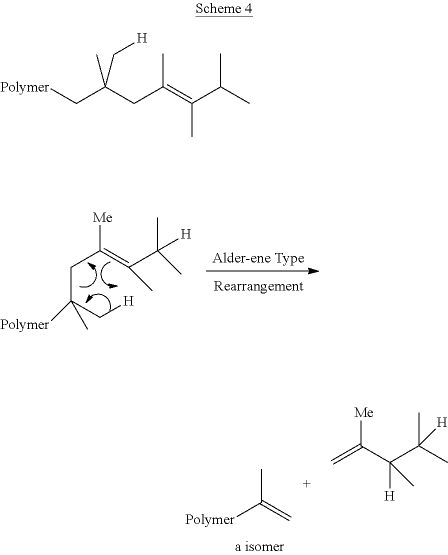

This approach for preparing PIB that is highly enriched in the a isomer, i.e. exo-PIB (although some tetra-PIB may still be present, depending on the extent to which the rearrangement step is carried out) can be particularly useful if the PIB is intended for reaction with maleic anhydride. That is because endo-PIB will not usually react with maleic anhydride at all. Thus, by converting the endo-PIB to either exo- or tetra-PIB, this approaches enables the use of a component of the PIB reagent which would otherwise be wasted. Further, the extent to which the rearrangement step is carried out may if desired be varied so as to control the ratio of exo- to tetra-PIB in the end product.

### BRIEF DESCRIPTION OF THE DRAWINGS

FIGS. 1-3 are sets of photographs of testing with respect to the formation of injector deposits.

FIG. 1 is a set of photographs of four injectors after using a base fuel.

FIG. 2 is a set of photographs of four injectors after using gasoline with an HR-PIB Mannich detergent additive.

FIG. 3 is a set of photographs of four injectors after using gasoline with a conventional PIB Mannich detergent additive.

FIG. 4 is a comparative graph plotting both conventional-PIB Mannich and HR-PIB Mannich.

### DETAILED DESCRIPTION OF THE INVENTION

The present invention provides a process of producing a compound in which a polyisobutylene (PIB) group is bonded to a substituent X,

wherein X is a group which comprises a polar moiety or which is suitable for being further reacted to convert it into a group comprising a polar moiety,
which process comprises reacting (i) PIB in which at least 50 mol % of the PIB macromolecules have a tri-substituted alkene group, with (ii) a source of X.

In a first preferred aspect, the process comprises contacting a source of X with a PIB reagent in which at least 50 mol % of the PIB macromolecules have a tri-substituted alkene group.

In a second preferred aspect, the process comprises contacting a source of X with a PIB reagent comprising both (a) PIB macromolecules having a tri-substituted alkene group, and (b) PIB macromolecules having a tetra-substituted alkene group,
wherein the proportion of PIB macromolecules having a tri-substituted and a tetra-substituted alkene group is at least 50 mol %, and
wherein the source of X and the PIB reagent are subjected to conditions under which PIB macromolecules having a tetra-substituted alkene group will react to produce PIB macromolecules having a tri-substituted alkene group. Preferably, said conditions comprise contacting the source of X and the PIB reagent with a source of protons, such as BF₃/HF.

In the second preferred aspect, the PIB reagent is preferably one in which at least 60 mol % of the PIB macromolecules have a tetra-substituted alkene group, more preferably at least 70 mol %, more preferably still at least 80 mol %, and yet more preferably at least 90 mol %.

Preferably, the tetra substituted alkene groups in the PIB macromolecules are located within or attached to a terminal C4 unit in the macromolecule. More preferably they are of the structure:

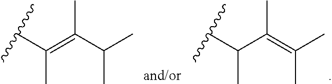

The present invention provides a product obtained or obtainable by a process as defined in claim 1 in which X is a group that is suitable for being further reacted to convert it into a group comprising a polar moiety, said product comprising a compound in which a PIB group is bonded to the substituent X. (Thus, this particular product of the invention may not have detergent properties, but can be further reacted to prepare a compound that does.)

The present invention also provides a detergent product obtained or obtainable by a process as defined in claim 1 in which X is a group comprising a polar moiety, said product comprising a compound which comprises a PIB group bonded to the substituent X.

Preferably, as a general matter the polar moiety is selected from:
(a) a moiety obtained or obtainable from a Mannich reaction of a hydroxyaromatic compound, an aldehyde and an amine;
(b) a moiety obtained or obtainable from succinic anhydride and having one or more hydroxyl and/or amino and/or amido and/or imido groups (preferably the moiety is a succinimide based on a mono- or polyamine containing up to 6 nitrogen atoms);
(c) a mono- or polyamino group having up to 6 nitrogen atoms, of which at least one nitrogen atom has basic properties,
(d) a quaternary ammonium salt of an amide or an ester,
(e) nitro groups, optionally in combination with hydroxyl groups,
(f) hydroxyl groups in combination with mono- or polyamino groups, in which at least one nitrogen atom has basic properties,
(g) carboxyl groups or their alkali metal or their alkaline earth metal salts,
(h) sulfonic acid groups or their alkali metal or alkaline earth metal salts,
(i) polyoxy-C₂- to -C₄-alkylene groups which are terminated by hydroxyl groups, by mono- or polyamino groups in which at least one nitrogen atom has basic properties, or by carbamate groups, and
(j) carboxylic ester groups.

When X is a group that is suitable for being further reacted to convert it into a group comprising a polar moiety, X may preferably be a hydroxyaromatic group such as phenol, cresol, resorcinol, hydroquinone, catechol, hydroxydiphenyl, benzylphenol, phenethylphenol, naphthol or tolylnaphthol. Phenol and cresol are most preferred.

The present invention provides a process of reacting the (non-detergent) product of the invention as defined above (i.e. the product comprising a compound in which a PIB group is bonded to the substituent X, wherein X is a group that is suitable for being further reacted to convert it into a group comprising a polar moiety) to convert X into a group comprising a polar moiety. This process comprises subjecting said product to conditions under which X will be converted into a group comprising a polar moiety. (In this regard, X may preferably be a hydroxyaromatic group, with the present invention also providing a process that comprises reacting said product with an aldehyde and an amine.) The present invention also provides a detergent product obtained or obtainable by such processes, said product comprising a compound in which a PIB group is bonded to a group comprising a polar moiety.

A preferred example of such a detergent product is a product obtained or obtainable from a Mannich reaction between an aldehyde, and amine and a PIB-hydroxyaromatic compound that has been prepared according to the invention. Such a PIB-hydroxyaromatic reagent has been found to be enriched in compounds wherein the PIB substituent is bonded to the aromatic ring in the following manner:

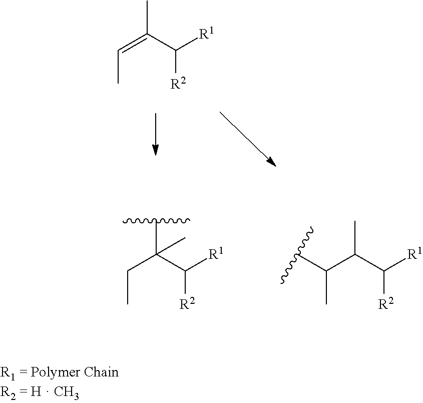

Thus, the present invention provides a detergent product obtained or obtainable from a Mannich reaction between an aldehyde, and amine and a PIB-hydroxyaromatic compound wherein at least 70 mol % (such as at least 75 mol %, at least 80 mol %, at least 85 mol %, at least 90 mol % or at least 95 mol %) of the molecules has the structure depicted above.

The hydroxyaromatic compounds may be based on e.g. phenol, cresol, resorcinol, hydroquinone, catechol, hydroxydiphenyl, benzylphenol, phenethylphenol, naphthol, tolylnaphthol, and mixtures thereof, among others. Phenol and cresol are preferred.

Representative aldehydes for use in the preparation of Mannich detergents include the aliphatic aldehydes such as formaldehyde, acetaldehyde, propionaldehyde, butyraldehyde, valeraldehyde, caproaldehyde, heptaldehyde, stearaldehyde. Aromatic aldehydes which may be used include benzaldehyde and salicylaldehyde. Illustrative heterocyclic aldehydes for use herein are furfural and thiophene aldehyde, etc. Also useful are formaldehyde-producing reagents such as paraformaldehyde, or aqueous formaldehyde solutions such as formalin. Most preferred is formaldehyde or formalin.

Representative amine reactants include, but are not limited to, alkylene polyamines having at least one suitably reactive primary or secondary amino group in the molecule. Other substituents such as hydroxyl, cyano, amido, etc., can be present in the polyamine. In a preferred embodiment, the alkylene polyamine is a polyethylene polyamine. Suitable alkylene polyamine reactants include ethylenediamine, diethylenetriamine, triethylenetetramine, tetraethylenepentamine, and mixtures of such amines having nitrogen contents corresponding to alkylene polyamines of the formula H2N-(A-NH—)″H, where A is divalent ethylene or propylene and n is an integer of from 1 to 10, preferably 1 to 4. The alkylene polyamines may be obtained by the reaction of ammonia and dihalo alkanes, such as dichloro alkanes.

The amine may preferably be an aliphatic diamine having one primary or secondary amino group and at least one tertiary amino group in the molecule. Examples of suitable polyamines include N, N, N″, N″-tetraalkyldialkylenetriamines (two terminal tertiary amino groups and one central secondary amino group), N, N, N′, N″-tetraalkyltrialkylenetetramines (one terminal tertiary amino group, two internal tertiary amino groups and one terminal primary amino group), N, N, N′, N″, N′″-pentaalkyltrialkylenetetramines (one terminal tertiary amino group, two internal tertiary amino groups and one terminal secondary amino group), N, N-dihydroxyalkyl-alpha, omega-alkylenediamines (one terminal tertiary amino group and one terminal primary amino group), N, N, N′-trihydroxyalkyl-alpha, omega-alkylenediamines (one terminal tertiary amino group and one terminal secondary amino group), tris (dialkylaminoalkyl) aminoalkylmethanes (three terminal tertiary amino groups and one terminal primary amino group), and similar compounds, wherein the alkyl groups are the same or different and typically contain no more than about 12 carbon atoms each, and which preferably contain from 1 to 4 carbon atoms each. Most preferably these alkyl groups are methyl and/or ethyl groups. Preferred polyamine reactants are N, N-dialkyl-alpha, omegaalkylenediamine, such as those having from 3 to about 6 carbon atoms in the alkylene group and from 1 to about 12 carbon atoms in each of the alkyl groups, which most preferably are the same but which can be different. Most preferred is N, N-dimethyl-1, 3-propanediamine and N-methyl piperazine.

Examples of polyamines having one reactive primary or secondary amino group that can participate in the Mannich condensation reaction, and at least one sterically hindered amino group that cannot participate directly in the Mannich condensation reaction to any appreciable extent include N-(tert-butyl)-1, 3propanediamine, N-neopentyl-1, 3-propanediamine, N-(tert-butyl)-1-methyl-1, 2ethanediamine, N-(tert-butyl)-1-methyl-1, 3-propanediamine, and 3,5-di (tertbutyl) aminoethylpiperazine.

As regards the preparation of such Mannich products, alkylation of the hydroxyaromatic compound may be performed in the presence of an alkylating catalyst at a temperature in the range of about 0 to about 200° C., preferably 0 to 100° C. Acidic catalysts may be used to promote Friedel Crafts alkylation. Possible catalysts for use in this regard include sulphuric acid, BF3, aluminum phenoxide, methanesulphonic acid, cationic exchange resin, acidic clays and modified zeolites.

The preferred configuration of the alkyl-substituted hydroxyaromatic compound is that of a para-substituted mono-alkylphenol or a para-substituted monoalkyl ortho-cresol.

The condensation reaction among the alkylphenol, the specified amine (s) and the aldehyde may be conducted at a temperature in the range of about 40 to about 200° C. The reaction can be conducted in bulk (no diluent or solvent) or in a solvent or diluent. Water is evolved and can be removed by azeotropic distillation during the course of the reaction. Typically, the Mannich reaction products are formed by reacting the alkyl-substituted hydroxyaromatic compound, the amine and aldehyde in the molar ratio of 1.0:0.5-2.0:1.0-3.0, respectively.

The present invention also provides a detergent product comprising a compound which comprises a PIB group bonded to the substituent X (in the case where X comprises a polar moiety), wherein the compound is of formula (I)

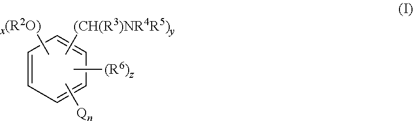

wherein
each R² is independently H or, together with the R⁴ or R⁵ moiety in an adjacent —CH(R³)NR⁴R⁵ group, is a divalent —CH(R³)— group;
x is 1, 2 or 3;
each R³ is independently H or hydrocarbyl comprising 1 to 10 carbon atoms;
each R⁴ and R⁵ is independently H, hydrocarbyl comprising 1 to 3000 carbon atoms which may be interrupted by one or more O, S and/or NR³ moieties, or together with R² forms a divalent —CH(R³)— group as defined above;
y is 1, 2 or 3;
each R⁶ is independently hydrocarbyl comprising 1 to 3000 carbon atoms which may be interrupted by one or more O, S and/or NR³ moieties;
z is 0, 1 or 2;
n is 1, 2 or 3; and
Q is the PIB group;
wherein in at least 50% of the compounds of formula (I), said PIB group is bonded to the central benzene ring such that it has the structure:

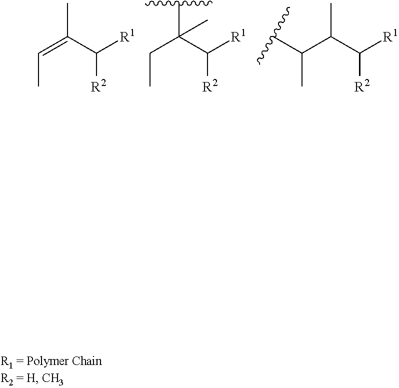

wherein
R¹, together with the moiety —CH₂—C(CH₃)(CH₂CH₃)— through which it is attached to the central benzene ring, represents the PIB group.

Preferably in formula (I):
any Q groups are para to an —OR² group,
any —CH(R³)NR⁴R⁵ groups are ortho to at least one —OR² group,
R⁶ (if present) is ortho to at least one —OR² group, and/or
R⁷ is —H or —CH₃.

Particularly preferred examples are compounds of formula (Ia) (Ib) and (Ic) below:

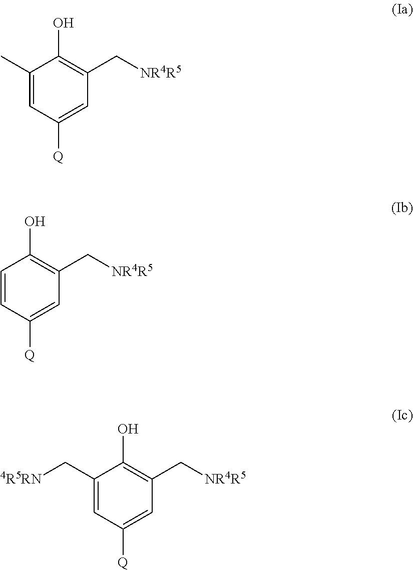

A preferred example for the group —NR⁴R⁵ is —NH(CH₂)₃N(CH₃)₂.

More generally in the context of the invention, in one preferred aspect the detergent products of the invention may comprise a compound wherein PIB is bonded to a group comprising a polar moiety, wherein at least 60 mol % of the molecules of the compound (such as at least 70 mol %, at least 80 mol %, at least 90 mol % or at least 95 mol %) have the structure:

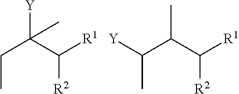

wherein
Y represents a group comprising a polar moiety, and
R¹, together with the moiety —CH₂—C(CH₃)(CH₂CH₃)— through which it is attached to Y, represents the PIB group.

The present invention also provides the use of a detergent product of the invention as defined herein as a detergent in a fuel or lubricant. Preferably the product is used as a detergent in gasoline in a direct injection gasoline (DIG) engine.

The present invention also provides the use of PIB which is enriched in tri-PIB (e.g. PIB in which at least 50, 60, 70, 80, 90 or 95 mol % of the PIB macromolecules have a tri-substituted alkene group), that alter the thermal stability and/or detergent effect of a compound which comprises a PIB group bonded to a substituent X, wherein X is a group comprising a polar moiety, as compared to a corresponding compound prepared from PIB in which is not enriched in tri-PIB (e.g. wherein less than 50 mol % of the PIB macromolecules have a tri-substituted alkene group).

The present invention provides a method of inhibiting and/or removing deposits in an internal combustion engine, which method comprises adding to the engine a product of the invention as defined herein. Preferably, the method is a method of inhibiting and/or removing injector deposits in a DIG engine, which method comprises fuelling the engine with gasoline comprising the product of the invention.

The present invention also provides an additive composition comprising a product as defined herein and a carrier fluid. The additive composition is preferably for use in adding the product to a fuel or lubricant composition. Thus, the present invention also provides a fuel or lubricant comprising a product of the invention. In a preferred embodiment the invention provides gasoline comprising a product of the invention.

The present invention provides PIB wherein at least 60 mol % (such as at least 70 mol %, at least 75 mol %, least 80 mol %, at least 85 mol %, at least 90 mol %, or at least 95 mol %) of the PIB macromolecules have a tetra substituted alkene group.

Preferably, the tetra substituted alkene group is located within or is attached to a terminal C4 unit in the PIB macromolecule, and more preferably it has the structure:

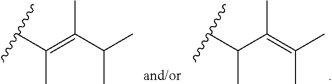

Preferably, at least 60 mol % (such as at least 70 mol %, at least 75 mol %, least 80 mol %, at least 85 mol %, at least 90 mol %, or at least 95 mol %) of said tetra substituted alkene moieties are of the structure below:

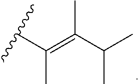 [SMILES: */C(C)=C(\C)C(C)C]

The present invention also provides a process of producing such PIB (i.e. PIB enriched in tetra-PIB), which process comprises subjecting a PIB starting material to double bond isomerisation in a molecular sieve.

In this regard, preferably at least 50 mol % (such as at least 60 mol %, at least 70 mol %, at least 80 mol %, or at least 85 mol %) of the macromolecules in the PIB starting material contain a terminal —CH₂—C(CH₃)═CH₂ group.

Preferably the molecular sieve is a zeolite.

Preferably the molecular sieve has parallel channels of size A×B, wherein A and B represent channel diameters perpendicular to each other and perpendicular also to the direction of the channel, and wherein A and B are both independently at least 0.1 nm (such as at least 0.2 nm, at least 0.3 nm, at least 0.4 nm, at least 0.5 nm, at least 0.6 nm, at least 0.7 nm, at least 0.8 nm, at least 0.9 nm, at least 1.0 nm, at least 1.1 nm, at least 1.2 nm, at least 1.3 nm, at least 1.4 nm, or at least 1.5 nm), and both are independently at most 3.0 nm (such as at most 2.9 nm, at most 2.8 nm, at most 2.7 nm, at most 2.6 nm, at most 2.5 nm, at most 2.4 nm, at most 2.3 nm, at most 2.2 nm, at most 2.1 nm, at most 2.0 nm, at most 1.9 nm, at most 1.8 nm, at most 1.7 nm, at most 1.6 nm, at most 1.5 nm, at most 1.4 nm, at most 1.3 nm, at most 1.2 nm, at most 1.1 nm, or at most 1.0 nm). These possible numerical limits are naturally subject to the requirement that the lower limit must be lower than the upper limit. Thus, if 1.0 nm is taken as the upper limit, then the lower limit must be 0.9 nm or lower. The precise upper and lower limit can be selected depending on the circumstances.

The present invention provides PIB wherein at least 50 mol % (such as at least 60 mol % at least 70 mol %, at least 80 mol %, at least 85 mol %, at least 90 mol %, or at least 95 mol %) of the PIB macromolecules have a tri substituted alkene group. This is a higher proportion than is seen in either conventional or HR PIB.

In this regard, preferably the alkene group appears at the end of the macromolecule and has the structure —CH₂—C(CH₃)═CHCH₃.

It is also preferred in this regard for the (tri-substituted) alkene group to be of the structure:

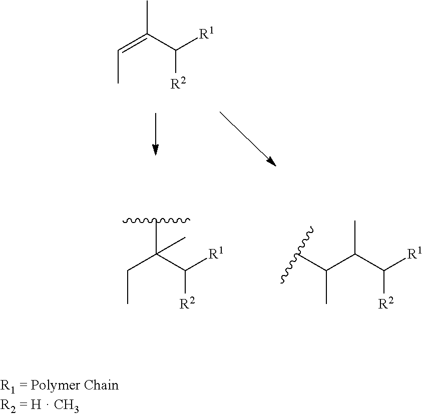

The present invention provides a process of producing PIB as defined above (i.e. PIB enriched in tri-PIB), which process comprises subjecting PIB wherein the proportion of PIB macromolecules having a tetra-substituted alkene group is at least 75 mol % (such as at least 80 mol %, at least 85 mol %, at least 90 mol %, or at least 95 mol %) to conditions under which PIB macromolecules having a tetra-substituted alkene group will react to produce PIB macromolecules having a tri-substituted alkene group. Preferably, this involves contacting the PIB with a source of protons, such as BF₃/HF.

The present invention provides Exo- and Endo-PIB combined to add to at least 90 mol %, both will isomerize to tetra-PIB along this pathway: alpha>beta>tetra.

The present invention provides a process of producing PIB as defined above (i.e. PIB enriched in exo-PIB), which process comprises subjecting PIB wherein the proportion of PIB macromolecules having a tetra-substituted alkene group is at least 50 mol % (such as at least 60 mol %, at least 70 mol %, at least 80 mol %, or at least 80 mol %) to conditions under which PIB macromolecules having a tetra-substituted alkene group will react to produce PIB macromolecules having a terminal vinylidene group. Preferably, this comprises subjecting the PIB wherein the proportion of PIB macromolecules having a tetra-substituted alkene group is at least 50 mol % to a thermal ene rearrangement.

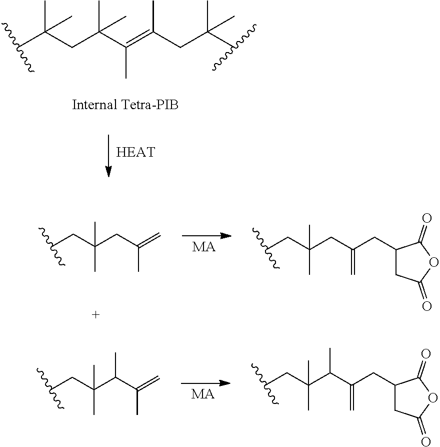

The detergent products of the invention are those products which comprise a compound in which a PIB group is bonded to a substituent X, in the case where X is a group comprising a polar moiety. In this regard, the size of the PIB group is not particularly limited. However, preferably it has a number average molecular weight of at least 400, such as at least 500, at least 600, at least 700, at least 800, or at least 900. It preferably has a number average molecular weight of no more than 5000, such as no more than 4000, or 3000, or 2000, or 1500, or 1200.

As regards the polar moiety, this is not specifically limited. By way of illustration, though, additives in which the types of polar moieties noted in options (b) to (j) (as listed above) appear are discussed below.

(b) Additives Comprising Moieties Derived from Succinic Anhydride and Having Hydroxyl and/or Amino and/or Amido and/or Imido Groups

These may correspond to derivatives of polyisobutenylsuccinic anhydride which are obtainable by reacting PIB with maleic anhydride. Particular interest attaches to derivatives with aliphatic polyamines such as ethylenediamine, diethylenetriamine, triethylenetetramine or tetraethylenepentamine (see e.g. U.S. Pat. No. 4,849,572.)

### (c) Additives Comprising Mono- or Polyamino Groups

These may be polyalkenemono- or polyalkenepolyamines based on polypropene or on highly reactive (i.e. having predominantly terminal double bonds, usually in the alpha- and beta-position) or conventional (i.e. having predominantly internal double bonds) polybutene or polyisobutene having Mn=300 to 5000. Such additives based on HR PIB, which can be prepared from the polyisobutene which may comprise up to 20% by weight of n-butene units by hydroformylation and reductive amination with ammonia, monoamines or polyamines, such as dimethylaminopropylamine, ethylenediamine, diethylenetriamine, triethylenetetramine or tetraethylenepentamine, are disclosed in particular in EP-A 244 616. When polybutene or polyisobutene having predominantly internal double bonds (usually in the beta and gamma position) are used as starting materials in the preparation of the additives, a possible preparative route is by chlorination and subsequent amination or by oxidation of the double bond with air or ozone to give the carbonyl or carboxyl compound and subsequent amination under reductive (hydrogenating) conditions. The amines used here for the amination may be the same as those used for the reductive amination of the hydroformylated HR PIB.

Further additives containing monoamino groups are the hydrogenation products of the reaction products of polyisobutenes having an average degree of polymerization P=5 to 100 with nitrogen oxides or mixtures of nitrogen oxides and oxygen, as described in particular in WO-A 97/03946.

Further preferred additives comprising monoamino groups (c) are the compounds obtainable from polyisobutene epoxides by reaction with amines and subsequent dehydration and reduction of the amino alcohols, as described in DE-A 196 20 262.

### (d) Quaternary Ammonium Salt of an Amide or an Ester

These may be quaternary ammonium amide and/or quaternary ammonium ester salt detergents, where the quaternized detergent comprises the reaction product of: (a) a non-quaternized amide and/or ester detergent having a tertiary amine functionality; and (b) a quaternizing agent. These additives may be derived from non-quaternized PIB succinamides and/or esters, which are dispersants/detergents that have tertiary amine functionality and an amide and/or ester group.

(e) Additives Comprising Nitro Groups, Optionally (if Appropriate) in Combination with Hydroxyl Groups

These may be reaction products of PIB having an average degree of polymerization P=5 to 100 or from 10 to 100 with nitrogen oxides or mixtures of nitrogen oxides and oxygen, as described in particular in WO-A 96/03367 and WO-A 96/03479. These reaction products are generally mixtures of pure nitropoly-isobutanes (e.g. alpha, beta-dinitropolyisobutane) and mixed hydroxynitropoly-isobutanes (e.g. alpha-nitro-beta-hydroxypolyisobutane).

(f) Additives Comprising Hydroxyl Groups in Combination with Mono- or Polyamino Groups

These may be in particular reaction products of PIB epoxides with ammonia or mono- or polyamines (see e.g. EP-A 476 485).

(g) Additives Comprising Carboxyl Groups or their Alkali Metal or Alkaline Earth Metal Salts

These may be olefin copolymers with maleic anhydride, wherein carboxyl groups may be converted to the alkali metal or alkaline earth metal salts with any remaining being reacted with alcohols or amines (see e.g. EP-A 307 815). Such additives can be used in combination with fuel detergents.

(h) Additives Comprising Sulfonic Acid Groups or their Alkali Metal or Alkaline Earth Metal Salts

These may be alkali metal or alkaline earth metal salts of an alkyl sulfosuccinate (see e.g. EP-A 639 632). Such additives can be used in combination with fuel detergents.

### (i) Additives Comprising Polyoxy-C2- to C4-Alkylene Moieties

These may preferably be polyethers or polyetheramines which are obtainable by reaction of C2- to C60-alkanols or PIB alcohols, C6- to C30-alkanediols, mono- or di-C2-C30-alkylamines, C1-C30-alkylcyclohexanols or C1-C30-alkylphenols with from 1 to 30 mol of ethylene oxide and/or propylene oxide and/or butylene oxide per hydroxyl group or amino group and, in the case of the polyetheramines, by subsequent reductive amination with ammonia, monoamines or polyamines (see e.g. EP-A 310 875, EP-A 356 725, EP-A 700 985 and U.S. Pat. No. 4,877,416). In the case of polyethers, such products also have carrier oil properties. Typical examples of these are tridecanol butoxylates, isotridecanol butoxylates, isononylphenol butoxylates and polyisobutenol butoxylates and propoxylates and also the corresponding reaction products with ammonia.

### (j) Additives Comprising Carboxylic Ester Groups

These may be esters of mono-, di- or tricarboxylic acids with long-chain alkanols or polyols, in particular those having a minimum viscosity of 2 mm²/s at 100° C., as described e.g. in DE-A 38 38 918. The mono-, di- or tricarboxylic acids used may be aliphatic or aromatic acids, and particularly suitable ester alcohols or ester polyols are long-chain representatives having, for example, from 6 to 24 carbon atoms. Typical representatives of the esters are adipates, phthalates, isophthalates, terephthalates and trimellitates of isooctanol, of isononanol, of isodecanol and of isotridecanol. Such products also have carrier oil properties.

### Possible Further Additives

The detergent products of the invention may be used together with further customary components and additives. These include primarily carrier oils without marked detergent action, for example mineral carrier oils (base oils), in particular those of the viscosity class “Solvent Neutral (SN) 500 to 2000”, and synthetic carrier oils based on olefin polymers having Mn=400 to 1800, in particular based on polybutene or polyisobutene (hydrogenated or nonhydrogenated), on poly-alpha-olefins or poly(internal olefin)s. The high tetra-PIB described herein can be used as a carrier fluid.

Useful solvents or diluents (when providing additive packages) are aliphatic and aromatic hydrocarbons such as Solvent Naphtha.

Further additives that may be used include corrosion inhibitors, for example based on ammonium salts of organic carboxylic acids, said salts tending to form films, or of heterocyclic aromatics for nonferrous metal corrosion protection, antioxidants or stabilizers, for example based on amines such as p-phenylenediamine, dicyclohexylamine or derivatives thereof or of phenols such as 2,4-di-tert-butylphenol or 3,5-di-tert-butyl-4-hydroxyphenylpropionic acid, demulsifiers, antistats, metallocenes such as ferrocene or methylcyclopentadienylmanganese tricarbonyl, lubricity additives such as certain fatty acids, alkenylsuccinic esters, bis(hydroxyalkyl) fatty amines, hydroxyacetamides or castor oil and also markers. Amines may also optionally be added to lower the pH of the fuel.

Also useful for can be combinations with corrosion inhibitors and/or lubricity additives based on carboxylic acids or fatty acids which may be present as monomeric and/or dimeric species.

In the preferred embodiment where the detergent products of the invention are added to gasoline fuel, they may be added in an amount of from 1 to 5000 ppm by weight, especially from 5 to 3000 ppm by weight, in particular from 10 to 1000 ppm by weight. The other components and additives mentioned are, if desired, added in amounts customary for this purpose.

### Examples

A comparison was made between the performances of the two Mannich detergents. This was done in a manner whereby the different alkylation yields that may be expected to arise in the initial step of preparing the PIB-phenol are addressed by isolating the PIB-phenol from both its starting materials, and then ensuring that an equal molar amount of each one was used to prepare the Mannich detergent.

To this end, two PIB-phenol reagents were prepared according to the protocol set out further below under the heading “Protocol for preparing PIB-phenols”. Chromatographic purification of both PIB-phenol products was carried out according to the protocol described for the conventional PIB-phenol. The outcome of this was as follows:
308.20 g of crude HR-PIB phenol yielded 244.09 g (79%) of PIB-free alkylate.
246.00 g of crude conventional-PIB phenol yielded 140.07 g (57%) of PIB-free alkylate.

The analysis of the purified PIB-phenols that were taken forward for use in preparing the Mannich detergent products is set out below.

| | | Conventional | High-Reactive |
|---|---|---|---|
| Property | Method | PIB | PIB |
| Residual | HPLC | None Detected | None Detected |
| PIB | | | |
| Phenol | GC | None Detected | None Detected |
| Mn | ¹³C NMR | 960 | 955 |
| Mn | Titration | 961 | 955 |
| % OH | Titration | 1.77 | 1.78 |
| mgKOH/g | Titration | 58.4 | 58.8 |

Both PIB-phenols were then subjected to the same Mannich reaction under the same conditions:

### Synthesis of the Conventional-PIB Phenol Di-Mannich:

A solution of 72.22 g of conventional (LR) PIB phenol with a hydroxyl number of 58.4 mgKOH/g (corresponding to 75.2 mmol phenol OH groups) in xylene (108 mL) was added to a 500 mL four neck round bottom flask equipped with a Dean-Stark trap and a reflux condenser. 4.56 g (152.0 mmol) of paraformaldehyde was added to the reaction vessel and heated to 90° C. After 15 minutes at 90° C., 15.53 g (152.0 mmol) of N,N-dimethyl-1,3-propanediamine was added by addition funnel in under 8 minutes in order to maintain an internal reaction temperature of 90-95° C. Upon complete addition, the reaction temperature was raised to 148° C. and held at this temperature for 2 h while water was continuously collected in the Dean-Stark trap. After two hours, the reaction was stopped and the reaction residue was concentrated to dryness on a rotary evaporator at 145° C. and 1 mbar yielding 81.0 g of the Mannich product as an amber oil.

### Synthesis of the HR-PIB Phenol Di-Mannich:

A solution of 76.4 g of HR-PIB phenol with a hydroxyl number of 58.8 mgKOH/g (corresponding to 73.5 mmol phenol OH groups) in xylene (121 mL) was added to a 500 mL four neck round bottom flask equipped with a Dean-Stark trap and a reflux condenser. 4.85 g (161.6 mmol) of paraformaldehyde was added to the reaction vessel and heated to 90° C. After 15 minutes at 90° C., 16.51 g (161.6 mmol) of N,N-dimethyl-1,3-propanediamine was added by addition funnel in under 8 minutes in order to maintain an internal reaction temperature of 90-95° C. Upon complete addition, the reaction temperature was raised to 148° C. and held at this temperature for 2 h while water was continuously collected in the Dean-Stark trap. After two hours, the reaction was stopped and the reaction residue was concentrated to dryness on a rotary evaporator at 145° C. and 1 mbar yielding 85.8 g of the Mannich product as an amber oil.

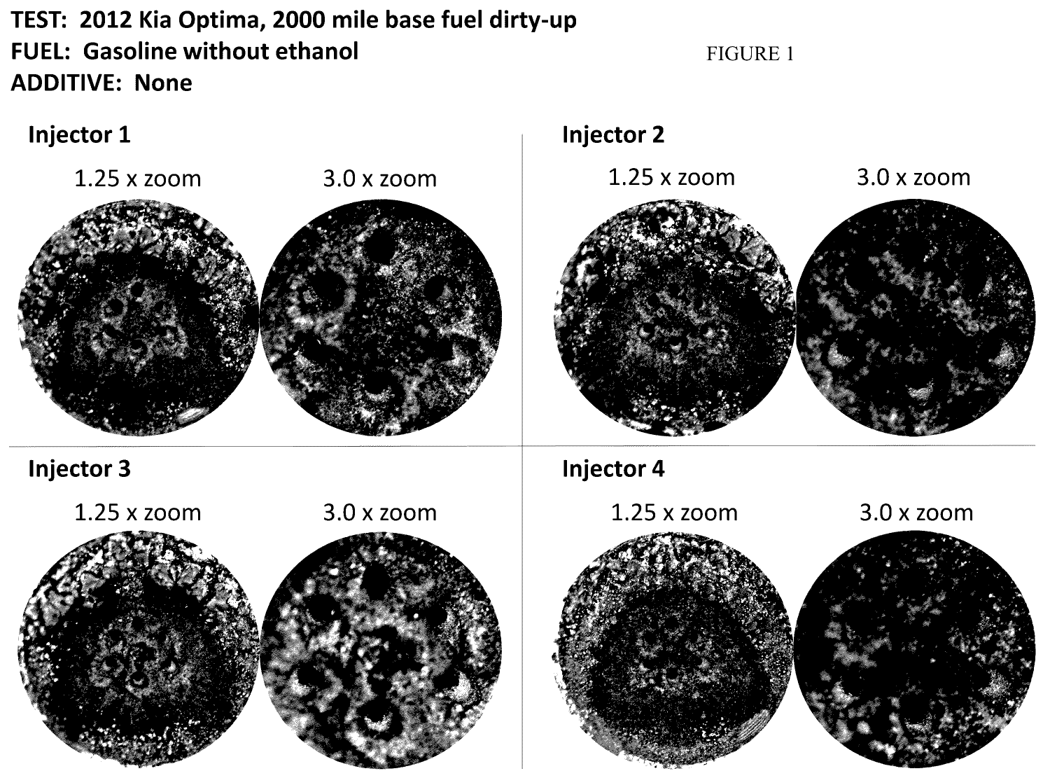

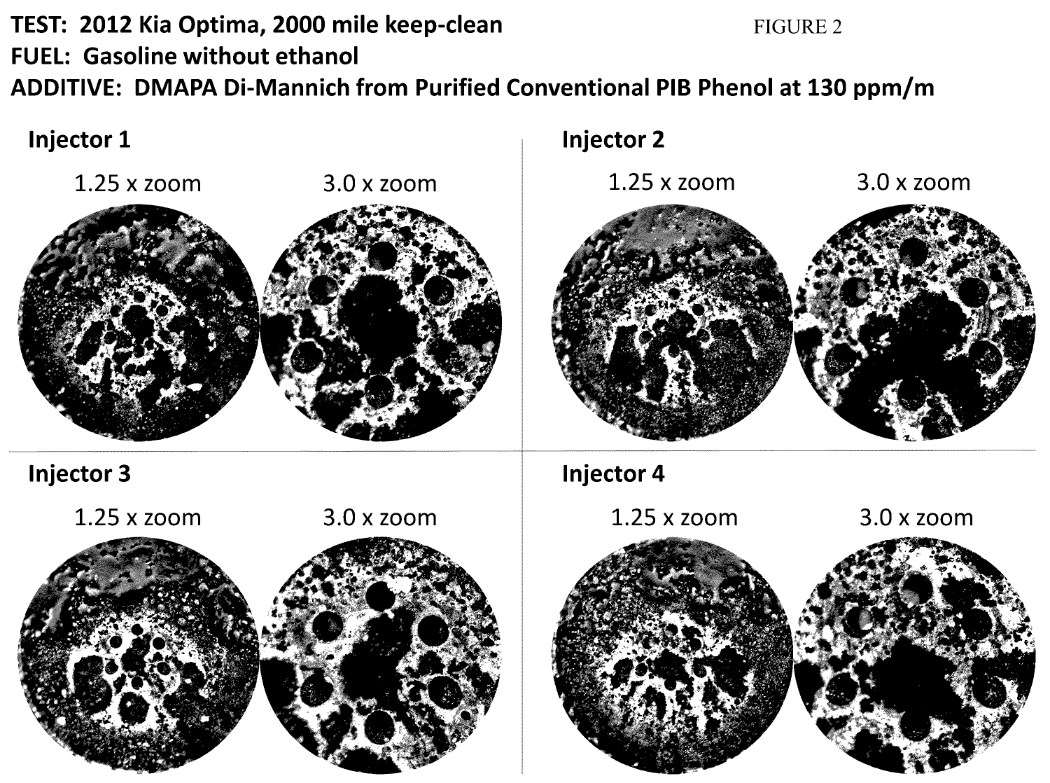

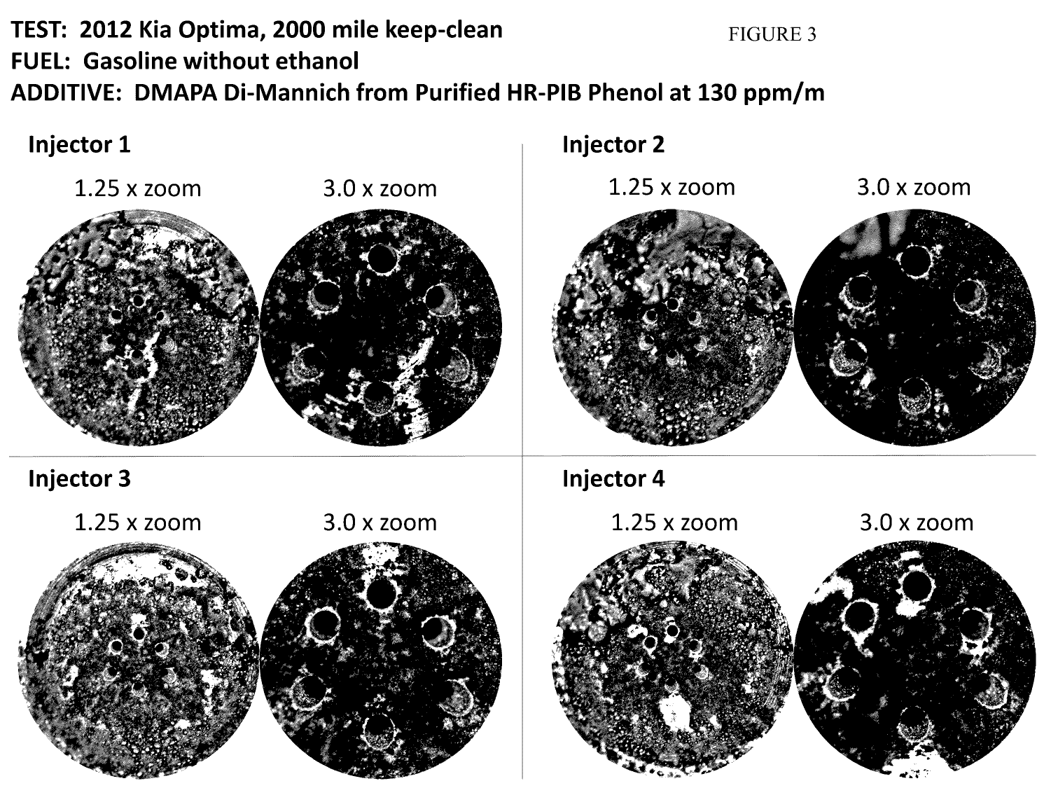

Each of the two Mannich detergents was then tested to assess their activity in a DIG engine. For comparison, a corresponding test was also conducted with base fuel. The tests were run under the following conditions:
Vehicle=2012 Kia Optima
Engine=4 cylinder, 1.6 L turbocharged direct injection
Test cycle=Chassis dynamometer, 2000 miles, run according to John Bennett TAE paper, Jan. 19-20, 2011 Stuttgart/Ostfidern
Fuel=Gasoline without ethanol
Additive=130 ppm/m of active Mannich Photographs of the injector faces of each of the four cylinders are set out in FIGS. 1 to 3.

As is evident from these images, both Mannich products reduced face deposits as compared to the base fuel. However, the Mannich in which the PIB group was derived from conventional PIB had a better detergent effect on the face deposits than the Mannich wherein the PIB group was derived from HR PIB.

Protocol for preparing PIB-phenols

### 1—Preparation of PIB-Phenol Using Conventional PIB

430.00 g (0.464 mol) conventional PIB was added to an addition funnel. The PIB was about 900 molecular weight and contained <10% alpha-vinylidene double bonds. 78.66 g (0.835 mol) phenol was dissolved in 50 g heptane at 40° C. under nitrogen in a 4-neck 2000 mL round bottomed flask. 13.18 g BF₃OEt₂ (0.092 mol) was added to the phenol/heptane mixture. The PIB was added to the reaction flask over the course of 70 minutes. The reaction was stirred at 40-42° C. for an additional 2 hours at which point it was quenched with ammonia gas. The reaction was diluted with heptane and filtered. Solvent was removed by rotary distillation and excess phenol was removed by vacuum distillation at 130° C. and 0.5 mmHg; 409 g (86% yield excluding transfer loss). The nominal molecular weight was 1284 as determined by Quantitative Carbon-NMR Integration, which corresponds to 1.32% OH.

### 2—Purification of Conventional-PIB-Phenol

311 g of PIB-Phenol from the crude reaction (1.32% OH) was dissolved in an equal volume of heptane and loaded onto a column containing 2 kg of silica gel. The column was eluted with 3 L of heptane to remove unreacted PIB. Subsequently 3 L of a 20% Ethyl Acetate/Heptane mixture was used to remove the active PIB-Phenol. The resulting solution was concentrated on a rotary evaporator at between 50 and 60° C. under vacuum. The final % OH was 1.90, thus indicating significant enrichment of the PIB-Phenol. The nominal molecular weight was 897 as determined by Quantitative Carbon-NMR integration.

### 3—Preparation of PIB-Phenol Using High-Reactive PIB

The reaction of High-Reactive PIB with phenol was carried out as described above for the conventional PIB. The PIB had an average molecular weight of about 900 and contained 60% alpha-vinylidene double bonds and 35% of the beta-isomer (95% terminal double bonds). The nominal molecular weight was 1060 corresponding to 1.60% OH as determined by Quantitative Carbon-NMR Integration.

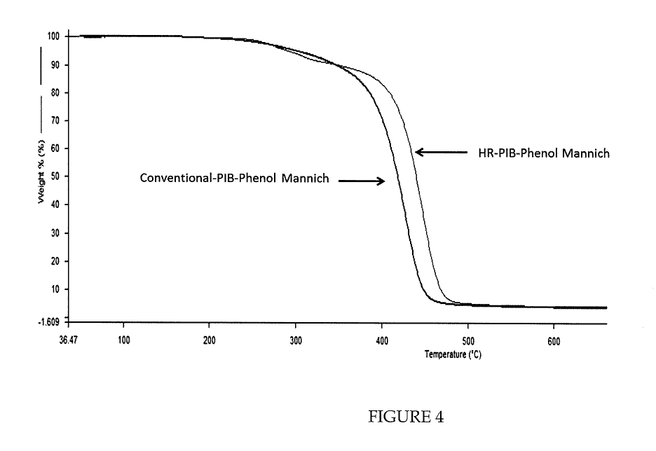

In addition to testing detergency, the conventional-PIB Mannich and HR-PIB Mannich were also analyzed for thermal stability. FIG. 4 below is a comparative graph plotting both conventional-PIB Mannich and HR-PIB Mannich. Surprisingly, the conventional-PIB Mannich is less thermally stable than the HR-PIB Mannich. Yet, as noted earlier, the conventional-PIB Mannich is a better detergent.

Other embodiments of the present disclosure will be apparent to those skilled in the art from consideration of the specification and practice of the disclosure disclosed herein. As used throughout the specification and claims, “a” and/or “an” may refer to one or more than one. Unless otherwise indicated, all numbers expressing quantities of ingredients, properties such as molecular weight, percent, ratio, reaction conditions, and so forth used in the specification and claims are to be understood as being modified in all instances by the term “about.” Accordingly, unless indicated to the contrary, the numerical parameters set forth in the specification and claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements. It is intended that the specification and examples be considered as exemplary only, with a true scope and spirit of the disclosure being indicated by the following claims.

1. A process of producing a compound in which a polyisobutylene (PIB) group is bonded to a substituent X,
wherein X is a group which comprises a polar moiety or which is suitable for being further reacted to convert it into a group comprising a polar moiety,
which process comprises reacting (i) PIB in which at least 50 mol % of the PIB macromolecules have a tri-substituted alkene group, with (ii) a source of X.

2. A process according to claim 1, which comprises contacting a source of X with a PIB reagent in which at least 70 mol % of the PIB macromolecules have a tri-substituted alkene group.

3. A process according to claim 1, which comprises contacting a source of X with a PIB reagent comprising both (a) PIB macromolecules having a tri-substituted alkene group, and (b) PIB macromolecules having a tetra-substituted alkene group,
wherein the proportion of PIB macromolecules having a tri-substituted or a tetra-substituted alkene group is at least 50 mol %, and
wherein the source of X and the PIB reagent are subjected to conditions under which PIB macromolecules having a tetra-substituted alkene group will react to produce PIB macromolecules having a tri-substituted alkene group.

4. A process according to claim 3, wherein said conditions comprise contacting the source of X and the PIB reagent with a source of protons.

5. A process according to claim 3, wherein the PIB reagent is one in which at least 50 mol % of the PIB macromolecules have a tetra-substituted alkene group.

6. A process according to claim 3, wherein the PIB reagent is one in which at least 70 mol % of the PIB macromolecules have a tetra-substituted alkene group, and wherein the tetra substituted alkene groups in the PIB macromolecules are located within or attached to a terminal C4 unit in the macromolecule, and are of the structure:

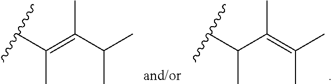

7. A product obtained or obtainable by a process as defined in claim 1 in which X is a group that is further reacted to convert it into a group comprising a polar moiety, said product comprising a compound in which a PIB group is bonded to the substituent X.

8. A detergent product obtained or obtainable by a process as defined in claim 1 in which X is a group comprising a polar moiety, said product comprising a compound which comprises a PIB group bonded to the substituent X.

9. A product according to claim 7 or 8, wherein the polar moiety is selected from:
(a) a moiety obtained or obtainable from a Mannich reaction of a hydroxyaromatic compound, an aldehyde and an amine;
(b) a moiety obtained or obtainable from succinic anhydride and having one or more hydroxyl and/or amino and/or amido and/or imido groups;
(c) a mono- or polyamino group having up to 6 nitrogen atoms, of which at least one nitrogen atom has basic properties,
(d) a quaternary ammonium salt of an amide or an ester,
(e) nitro groups, optionally in combination with hydroxyl groups,
(f) hydroxyl groups in combination with mono- or polyamino groups, in which at least one nitrogen atom has basic properties,
(g) carboxyl groups or their alkali metal or their alkaline earth metal salts,
(h) sulfonic acid groups or their alkali metal or alkaline earth metal salts,
(i) polyoxy-C₂- to -C₄-alkylene groups which are terminated by hydroxyl groups, by mono- or polyamino groups in which at least one nitrogen atom has basic properties, or by carbamate groups, and
(j) carboxylic ester groups.

10. A product according to claim 7, wherein X is a hydroxyaromatic group selected from the group consisting of phenol, cresol, resorcinol, hydroquinone, catechol, hydroxydiphenyl, benzylphenol, phenethylphenol, naphthol or tolylnaphthol, and mixtures thereof.

11. A process of reacting a product as defined in claim 7 to convert it into a group comprising a polar moiety, which process comprises subjecting the product as defined in claim 7 to conditions under which it will be converted into a group comprising a polar moiety.

12. A process according to claim 11, wherein X is a hydroxyaromatic group, and said process comprises reacting said product with an aldehyde and an amine.

13. A detergent product obtained or obtainable by a process as defined in claim 11, said product comprising a compound which a PIB group is bonded to a group comprising a polar moiety.

14. A product according to claim 13, wherein the compound is of formula (I) 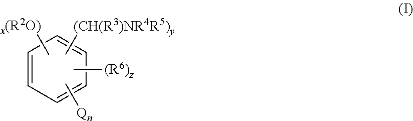
wherein
each R² is independently H or, together with the R⁴ or R⁵ moiety in an adjacent —CH(R³)NR⁴R⁵ group, is a divalent —CH(R³)— group;
x is 1, 2 or 3;
each R³ is independently H or hydrocarbyl comprising 1 to 10 carbon atoms;
each R⁴ and R⁵ is independently H, hydrocarbyl comprising 1 to 3000 carbon atoms which may be interrupted by one or more O, S and/or NR³ moieties, or together with R² forms a divalent —CH(R³)— group as defined above;
y is 1, 2 or 3;
each R⁶ is independently hydrocarbyl comprising 1 to 3000 carbon atoms which may be interrupted by one or more O, S and/or NR³ moieties;
z is 0, 1 or 2;
n is 1, 2 or 3; and
Q is the PIB group;
wherein in at least 60% of the compounds of formula (I), said PIB group is bonded to the central benzene ring such that it has the structure: 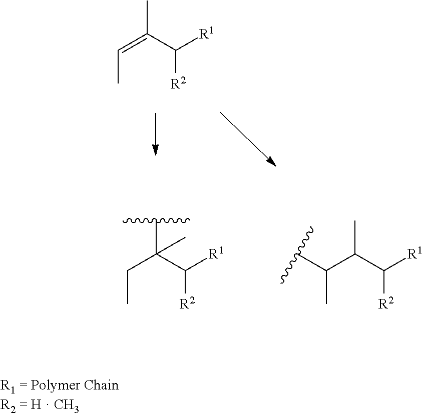
wherein
R¹, together with the moiety —CH₂—C(CH₃)(CH₂CH₃)— through which it is attached to the central benzene ring, represents the PIB group.

15. Use of a product as defined in claim 8 or 13 as a detergent in a fuel or lubricant.

16. Use according to claim 15, wherein the product is used as a detergent in gasoline in a direct injection gasoline (DIG) engine.

17. Use of PIB in which at least 50 mol % of the PIB macromolecules have a tri-substituted alkene group, to improve the detergent effect of a compound as defined in claim 8 or 13, as compared to a corresponding compound prepared from PIB in which less than 50 mol % of the PIB macromolecules have a tri-substituted alkene group.

18. A method of inhibiting and/or removing deposits in an internal combustion engine, which method comprises adding to the engine a product as defined in claim 8 or 13.

19. A method according to claim 18, which is a method of inhibiting and/or removing injector deposits in a DIG engine, which method comprises fuelling the engine with gasoline comprising a product as defined in claim 8 or 13.

20. An additive composition comprising a product as defined in claim 8 or 13 and a carrier fluid.

21. A fuel or lubricant comprising a product as defined in claim 8 or 13.

22. Gasoline comprising a product as defined in claim 8 or 13.

23. A detergent product comprising a product of the reaction of a polar moiety and a PIB wherein at least 50 mol % of the PIB macromolecules have a tri or tetra substituted alkene group.

24. A detergent product according to claim 23, wherein at least 80 mol % of the PIB macromolecules have a tetra substituted alkene group.

25. A detergent product according to claim 23, wherein at least 95 mol % of the PIB macromolecules have a tetra substituted alkene group.

26. A detergent product according to claim 23, wherein said tetra substituted alkene group is located within or is attached to a terminal C4 unit in the PIB macromolecule, and has the structure:

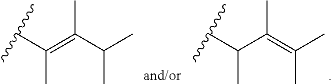

27. A detergent product according to claim 26, wherein at least 60 mol % of said tetra substituted alkene moieties are of the structure:

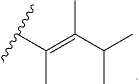 [SMILES: */C(C)=C(\C)C(C)C]

28. PIB according to claim 26, wherein at least 80 mol % of said tetra substituted alkene moieties are of the structure:

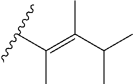 [SMILES: */C(C)=C(\C)C(C)C]

29. A detergent product according to claim 26, wherein at least 95 mol % of said tetra substituted alkene moieties are of the structure:

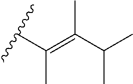 [SMILES: */C(C)=C(\C)C(C)C]

30. A process of producing a detergent product as defined in claim 23, which process comprises subjecting a PIB starting material to double bond isomerisation in a molecular sieve.

31. A process according to claim 30, wherein at least 50 mol % of the macromolecules in the PIB starting material contain a terminal —CH₂—C(CH₃)═CH₂ group.

32. A process according to claim 30, wherein the molecular sieve is a zeolite.

33. A process according to claim 30, wherein the molecular sieve has parallel channels of size A×B, wherein A and B represent channel diameters perpendicular to each other and perpendicular also to the direction of the channel, and wherein A and B are both independently at least 0.3 nm, preferably at least 0.5 nm, and are both independently at most 3.0 nm, preferably at most 2.0 nm.

34. A detergent product according to claim 23, wherein at least 75 mol % of the PIB macromolecules have a tri substituted alkene group.

35. A detergent product according to claim 23, wherein at least 95 mol % of the PIB macromolecules have a tri substituted alkene group.

36. A detergent product according to claim 23, wherein the alkene group appears at the end of the macromolecule and has the structure —CH₂—C(CH₃)═CHCH₃.

37. A detergent product according to claim 23, wherein the alkene group is of the structure:

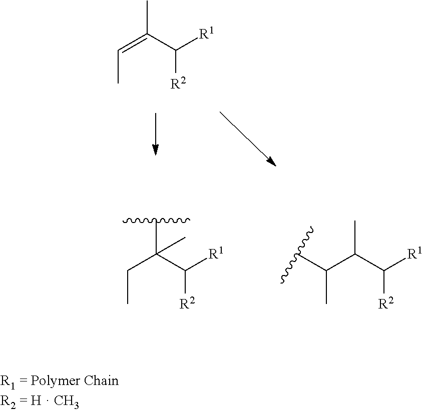

38. A process of producing a detergent product as defined in claim 34, which process comprises subjecting PIB wherein the proportion of PIB macromolecules having a tetra-substituted alkene group is at least 75 mol % to conditions under which PIB macromolecules having a tetra-substituted alkene group will react to produce PIB macromolecules having a tri-substituted alkene group.

39. A process according to claim 38, wherein said conditions comprise contacting the PIB with a source of protons.

40. A process of producing a detergent product as defined in claim 35, which process comprises subjecting PIB wherein the proportion of PIB macromolecules having a tetra-substituted alkene group as at least 95 mol % to conditions under which PIB macromolecules having a tetra-substituted alkene group will reach to produce PIB macromolecules having a terminal vinylidene group.

41. A process according to claim 40, which comprises subjecting the PIB wherein the proportion of PIB macromolecules having a tetra-substituting alkene group is at least 95 mol % to a thermal rearrangement.
